(19) United States
(12) Patent Application Publication
(10) Pub. No.: US 2009/0197552 A1
(43) Pub. Date: Aug. 6, 2009

(54) BANDWIDTH TUNABLE MIXER-FILTER USING LO DUTY-CYCLE CONTROL

(76) Inventors: Peter Kurahashi, Corvallis, OR (US); Pavan Kumar Hanumolu, Corvallis, OR (US); Un-Ku Moon, Corvallis, OR (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/348,971

(22) Filed: Jan. 6, 2009

Related U.S. Application Data
(60) Provisional application No. 61/019,436, filed on Jan. 7, 2008.

(51) Int. Cl. H04B 1/26

(52) U.S. Cl. 455/196.1

(57) ABSTRACT

The present invention relates generally to a bandwidth tunable mixer and more particularly but not exclusively to a mixer having a bandwidth that is tunable in response to a variation in the duty-cycle of a local oscillator.

### RELATED APPLICATIONS

This is application claims the benefit of priority of U.S. Provisional Application No. 61/019,436, filed on Jan. 7, 2008, the entire contents of which application are incorporated herein by reference

### FIELD OF THE INVENTION

The present invention relates generally to a bandwidth tunable mixer and more particularly but not exclusively to a mixer having a bandwidth that is tunable in response to a variation in the duty-cycle of a local oscillator.

### BACKGROUND OF THE INVENTION

Mixers are commonly used in communication systems to translate signals from radio or intermediate frequencies to baseband frequencies. A commonly used down-conversion mixer is the double-balanced passive mixer 101 shown in FIG. 1. The input (Vin) mixes with the local oscillator (LO) and appears at the output (Vout). The switches 2 are often implemented as MOSFETs in a solid-state implementation.

A commonly used circuit architecture 104 for the passive mixer 101 is shown in FIG. 2. (Sacchi, E., et al., “A 15 mW, 70 kHz 1/f corner direct conversion CMOS receiver,” Custom Integrated Circuits Conference, 2003. Proceedings of the IEEE 2003, vol., no., pp. 459-462, 21-24 Sep. 2003. Valla, M., et al., “A 72-mW CMOS 802.11a direct conversion front-end with 3.5-dB NF and 200-kHz 1/f noise corner,” Solid-State Circuits, IEEE Journal of, vol. 40, no. 4, pp. 970-977, April 2005.) The passive mixer 102 is fed into the virtual ground of an opamp based active RC filter 103. The filter 103 can be part of a baseband filter for channel selection. In solid-state implementation, the absolute value of the resistors and capacitors can change widely over process and temperature. To adjust for process and temperature the filter bandwidth needs to be tunable when used for channel selection. Continuous bandwidth tuning of the RC filter is possible using continuously variable MOSFET capacitors or MOSFET resistors, and discrete tuning can be obtained through switchable capacitor or resistor arrays. However, a problem with continuously variable MOSFET resistors or MOSFET capacitors is that they are non-linear and have limited tuning range at low supply voltages. In addition, discrete tuning methods have limited resolution and can cause errors when switching while the mixer is active. Accordingly, it would be an advance in the art of bandwidth tunable mixers to provide mixers which are highly linear and suitable for use with low supply voltages.

### SUMMARY OF THE INVENTION

In one of its aspects the present invention provides a passive current mixer having a bandwidth that is tunable in response to a variation in the duty-cycle of a local oscillator. The mixer may include a local oscillator for producing an oscillator waveform having a duty-cycle and may include an opamp having first and second feedback loops. Each feedback loop may include a first switch disposed therein which is driven by the oscillator waveform. In addition, each feedback loop may include a second switch disposed therein driven by the complement of the oscillator waveform. The bandwidth of the mixer may be tuned by varying the duty-cycle of the oscillator waveform, i.e., by varying the duty-cycle per se or by varying a relative phase between local oscillator waveforms having a constant duty-cycle. That is, for example, the mixer may comprise a third switch disposed within one of the two feedback loops, with the third switch driven by a phase-delayed version of the oscillator waveform. The phase delay may be varied while maintaining the period of the duty-cycle constant to effect bandwidth tuning.

In this regard, the present invention provides a passive current mixer having a bandwidth that is tunable in response to a variation in the phase delay of a local oscillator. The passive current mixer may include a local oscillator for producing an oscillator waveform having a duty-cycle and an opamp having two feedback loops. Each feedback loop may include a first and second switch connected in series disposed within the feedback loop. The first switch may be driven by the oscillator waveform, and the second switch may be driven by a phase delayed version of the oscillator waveform. The bandwidth of the mixer may be tuned by varying the phase delay of the oscillator waveform with the duty-cycle held constant. In addition, the passive current mixer may include a third and fourth switch connected in series within the feedback loop. The third switch may be driven by the complement of the oscillator waveform and the second switch driven by a phase delayed version of the complement of the oscillator waveform.

In yet another of its aspects, the present invention provides an active mixer having a bandwidth that utilizes Gilbert-type mixers and is tunable in response to a variation in the duty-cycle of a local oscillator. The active mixer may include a local oscillator for producing an oscillator waveform having a duty-cycle, a first Gilbert-type mixer having an input and an output, and a second Gilbert-type mixer. The second Gilbert-type mixer may have an input connected to the output of the first Gilbert-type mixer. The second Gilbert-type mixer may also have an output connected to the output of the first Gilbert-type mixer and connected to the input of the second Gilbert-type mixer. The first and second Gilbert-type mixers may each be driven by the oscillator waveform and the complement of the oscillator waveform. In addition, a capacitor may be disposed between ground and the output of the first Gilbert-type mixer to effect filtering. In such a configuration the bandwidth of the active mixer may be tuned by varying the duty-cycle of the oscillator waveform.

### BRIEF DESCRIPTION OF THE DRAWINGS

The foregoing summary and the following detailed description of the preferred embodiments of the present invention will be best understood when read in conjunction with the appended drawings, in which:

FIG. 1 schematically illustrates a double-balanced passive mixer, a commonly used down-conversion mixer;

FIG. 2 schematically illustrates the double-balanced passive mixer of FIG. 1 connected to the virtual ground of an active RC filter;

FIG. 3 schematically illustrates an exemplary bandwidth tunable mixer in accordance with the present invention using LO (local oscillator) pulse width modulation;

FIG. 4 illustrates the LO waveforms and simulated 1^{st} harmonic conversion gains for three different LO duty-cycles for the mixer of FIG. 3;

FIG. 5 schematically illustrates an exemplary bandwidth tunable mixer in accordance with the present invention using LO phase shifting;

FIG. 6 schematically illustrates an exemplary bandwidth tunable mixer in accordance with the present invention using LO pulse width modulation with LO outside the feedback loop;

FIG. 7 schematically illustrates an exemplary bandwidth tunable Gilbert-type mixer in accordance with the present invention using LO pulse width modulation;

FIG. 8a schematically illustrates another exemplary bandwidth tunable mixer in accordance with the present invention;

FIG. 8b illustrates clock waveforms and simulated mixer-filter conversion gains for three different clock delays for the mixer of FIG. 8a;

FIG. 9 schematically illustrates exemplary master-slave tuning for use with the mixer of FIG. 8a;

FIG. 10 illustrates a micrograph of a prototype die of the mixer of FIG. 8a along with master-slave tuning;

FIG. 11 illustrates a graph showing conversion gains over a ±50% tuning range for the mixer of FIG. 8a; and

FIG. 12 illustrates a graph showing the measured third-order intercept point (IIP3) for the mixer of FIG. 8a.

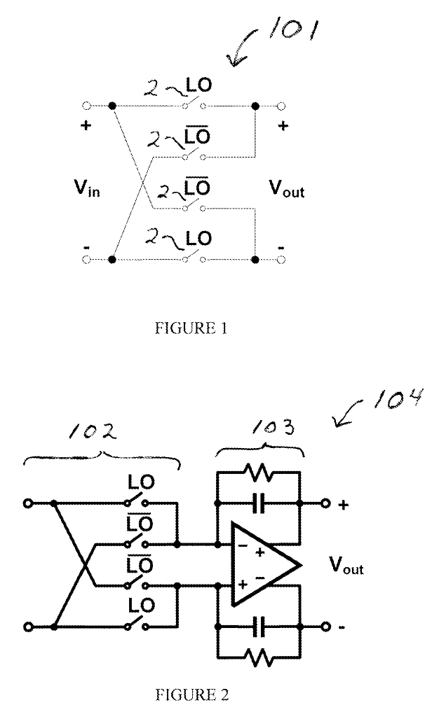

### DETAILED DESCRIPTION

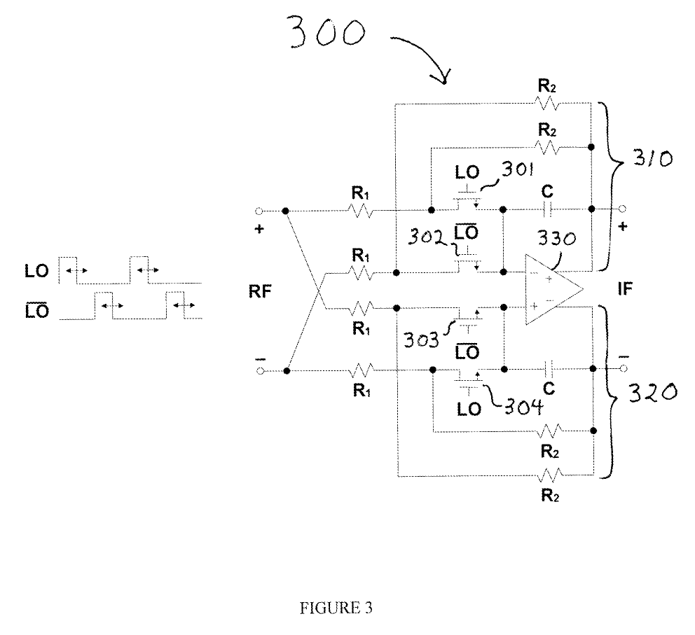

Turning first to FIG. 3, an exemplary configuration of a bandwidth tunable mixer-filter 300 in accordance with the present invention is shown in the form of a passive current mixer having a bandwidth that is tunable in response to a variation in the duty-cycle of a local oscillator (LO). The mixer-filter 300 overcomes the afore-mentioned bandwidth tuning problems through the use of LO pulse width modulation (PWM) with the duty-cycle of the LO varied to adjust the mixer bandwidth. In particular, the mixer-filter 300 accomplishes down conversion mixing and IF filtering in the same stage with a single opamp 330.

The mixer-filter 300 includes an input RF, an output IF, and an opamp 330 having differential inputs and outputs disposed there-between. The opamp 330 has a first feedback loop 310 disposed between a first output of the opamp 330 and the input of the opamp 330 having opposite polarity to that of the first output. Likewise, the opamp 330 has a second feedback loop 320 disposed between the second output of the opamp 330 and the input of the opamp 330 having the opposite polarity to that of the second output. The first feedback loop 310 includes a first switch 301 driven by the local oscillator and a second switch 302 driven by the complement of the local oscillator. In a similar manner the second feedback loop 320 includes a first switch 304 driven by the local oscillator and a second switch 303 driven by the complement of the local oscillator. Also included in the feedback loops 310, 320 are resistors R₂ and capacitor C disposed in the locations indicated in FIG. 3. That is, the capacitor C of the first feedback loop 310 may be disposed directly between the first output of the opamp 330 and the input having opposite polarity to that of the first output. The capacitor C of the second feedback loop 320 may be disposed directly between the second output of the opamp 330 and the input having the opposite polarity to that of the second output. For each switch 301, 302, 303, 304 of the first and second feedback loops 310, 320 a respective resistor R₂ may be disposed directly between the respective output of the opamp 330 and the input side of the respective switch 301, 302, 303, 304. In addition, the positive terminal of the input RF may be connected with the input of LO switch 301 and LO-complement switch 303 via a resistor R₁ disposed there-between, and the negative terminal of the input RF may be connected with the input of LO switch 304 and LO-complement switch 302 via a resistor R₁ disposed there-between to provide a double-balanced passive mixer 300. In one exemplary implementation of the mixer-filter 300, R₁ may be 8 kΩ, R₂ may be 25 kΩ, and C may be 5 pF. More generally, R₁ may be in the range 10Ω to 500 kΩ, R₂ may be in the range 10Ω to 500 kΩ, and C may be in the range 1 pF to 1 nF.

The switches 301, 302, 303, 304 are shown implemented as MOSFETs and provide both down conversion mixing with the local oscillator and corner frequency tuning of the mixer-filter 300 through duty-cycle control. Because the switches 301, 302, 303, 304 are fully on when they are active, their on resistance is low, and their distortion is minimized. At the same time most of the voltage is dropped across the feedback loop resistors R₂ improving the linearity. In addition, since the switches 301, 302, 303, 304 are placed inside respective feedback loops 310, 320, their low frequency distortion is decreased. Because tuning is done in the time-domain using PWM, the tuning range is independent of supply voltage. Tuning can be done continuously without limits in resolution.

Turning next to the operation of the mixer-filter 300, Equation 1 shows the 3 dB bandwidth of the mixer-filter 300 as a function of LO duty-cycle. In Equation 1, Δ is the duty-cycle of the LO clock as a decimal, and f₀ is the cutoff frequency when the clock duty-cycle is 0.5, or equivalently when conduction occurs over the entire clock period.

f_{bw}=2·Δ·f₀ (1)

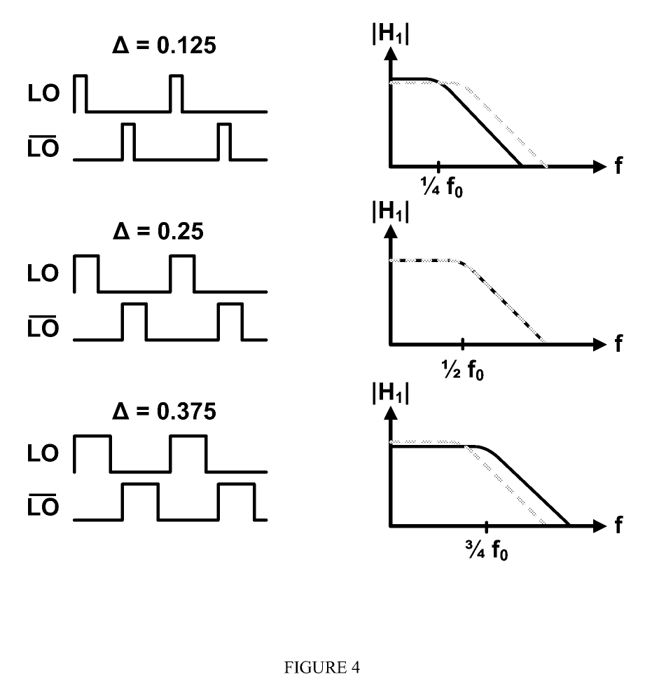

FIG. 4 shows the LO waveforms and the corresponding 1^{st} harmonic conversion gains of the mixer-filter 300 for three different LO duty-cycles, Δ=0.125, Δ=0.25, and Δ=0.375. The LO and the complement of LO have the same duty-cycle and are shifted 180° in phase, which allows the mixer-filter 300 to provide double-balanced mixing such that even-order mixing terms are suppressed. The conversion gain bandwidth follows from Equation 1.

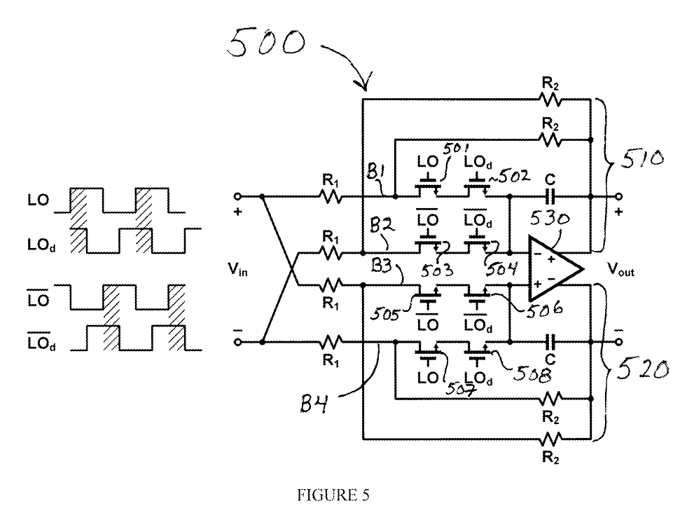

If the LO is high frequency, it may be difficult to generate a small duty-cycle clock. Consequently, FIG. 5 shows an alternative mixer-filter 500 in accordance with the present invention for generating a PWM LO at high frequencies. The mixer-filter 500 includes an input Vᵢₙ, an output Vₒᵤₜ, and an opamp 530 having differential inputs and outputs disposed there-between. The opamp 530 has a first feedback loop 510 disposed between a first output of the opamp 530 and the input of the opamp 530 having opposite polarity to that of the first output. Likewise, the opamp 530 has a second feedback loop 520 disposed between the second output of the opamp 530 and the input of the opamp 530 having the opposite polarity to that of the second output. The first feedback loop 510 includes a first branch B1 and a second branch B2, and the second feedback loop 520 includes a first branch B3 and a second branch B4. The first branch B1 of the first feedback loop 510 and the second branch B4 of the second feedback loop 520 each include a respective first switch 501, 507 driven by the local oscillator and a respective second switch 502, 508 driven by a phase delayed form of the local oscillator. In addition, second branch B2 of the first feedback loop 510 and the first branch B3 of the second feedback loop 520 each include a respective first switch 503, 505 driven by the complement of the local oscillator and a respective second switch 504, 506 driven by a phase delayed form of the complement of the local oscillator. For each of the branches B1, B2, B3, B4 the associated pairs of switches (e.g., switch pairs 501-502) are disposed in series. That is, two series mixing switches, e.g., 501-502, are used in each branch, e.g., B1.

Also included in the feedback loops 510, 520 are resistors R₂ and capacitor C disposed in the locations indicated in FIG. 5. The capacitor C of the first feedback loop 510 may be disposed directly between the first output of the opamp 530 and the input having opposite polarity to that of the first output. The capacitor C of the second feedback loop 520 may be disposed directly between the second output of the opamp 530 and the input having the opposite polarity to that of the second output. For each non-delayed LO switch 501, 503, 505, 507 of the first and second feedback loops 510, 520 a respective resistor R₂ may be disposed directly between the respective output of the opamp 530 and the input side of the respective non-delayed LO switch 501, 503, 505, 507. In addition, the positive terminal of the input Vᵢₙ may be connected with the input of LO switch 501 and LO-complement switch 505 via a resistor R₁ disposed there-between, and the negative terminal of the input Vᵢₙ may be connected with the input of LO switch 507 and LO-complement switch 505 via a resistor R₁ disposed there-between. In one exemplary implementation of the mixer-filter 500, R₁ may be 8 kΩ, R₂ may be 25 kΩ, and C may be 5 pF. More generally, R₁ may be in the range 10Ω to 500 kΩ, R₂ may be in the range 10Ω to 500 kΩ, and C may be in the range 1 pF to 1 nF.

In operation, each LO may maintain a 50% duty-cycle is illustrated in FIG. 5. The relative phase of the LO between each of the series switches 501-502, 503-504, 505-506, 507-508 (shown by the shaded region on the LO waveforms of FIG. 5) may be varied to adjust the bandwidth of the mixer filter 500. Because the clocks maintain a 50% duty-cycle, the clocks can be generated at much higher frequency than a clock with a small duty-cycle.

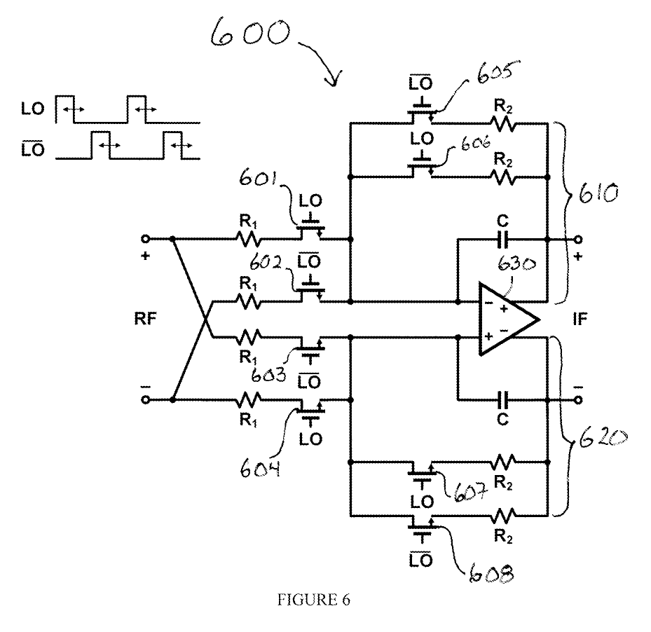

In yet a further exemplary configuration of the present invention, the circuit of FIG. 3 can be modified to move the LO outside the forward path of the feedback loop, as shown in FIG. 6. In this regard, FIG. 4 also applies to the filter-mixer 600 of FIG. 6. Like the filter-mixer 300 of FIG. 3, the filter-mixer 600 of FIG. 6 includes an input RF, an output IF, and an opamp 630 having differential inputs and outputs disposed there-between. The opamp 630 has a first feedback loop 610 disposed between a first output of the opamp 630 and the input of the opamp 630 having opposite polarity to that of the first output. Likewise, the opamp 630 has a second feedback loop 620 disposed between the second output of the opamp 630 and the input of the opamp 630 having the opposite polarity to that of the second output. The first feedback loop 610 includes a first switch 606 driven by the local oscillator and a second switch 605 driven by the complement of the local oscillator. In a similar manner the second feedback loop 620 includes a first switch 607 driven by the local oscillator and a second switch 608 driven by the complement of the local oscillator. Also included in the feedback loops 610, 620 are resistors R₂ and capacitor C. The capacitor C of the first feedback loop 610 may be disposed directly between the first output of the opamp 630 and the input having opposite polarity to that of the first output. The capacitor C of the second feedback loop 620 may be disposed directly between the second output of the opamp 630 and the input having the opposite polarity to that of the second output. For each switch 605, 606, 607, 608 of the first and second feedback loops 610, 620 a respective resistor R₂ may be disposed directly between the respective output of the opamp 630 and the output side of the respective switch 605, 606, 607, 608.

In addition, the positive terminal of the input RF may be connected with the input of an LO input-switch 601 and LO-complement input-switch 603 via a resistor R₁ disposed there-between, with the LO input-switch 601 connected with the negative input of the opamp 630 and the LO-complement input-switch 603 connected with the positive input of the opamp 630. The negative terminal of the input RF may be connected with the input of an LO input-switch 604 and LO-complement input-switch 602 via a resistor R₁ disposed there-between, with the LO input-switch 604 connected with the positive input of the opamp 630 and the LO-complement input-switch 602 connected with the negative input of the opamp 630.

Input-switches 601, 602, 603, 604 at the input branches provide the mixing function. The switches 605, 606, 607, 608 in the feedback loops 610, 620 provide bandwidth control using the duty-cycle of the LO. The conversion gain of the mixer 600 can be adjusted by varying the relative duty-cycles of the switches 601, 602, 603, 604 in the input branches versus the switches 605, 606, 607, 608 in the feedback paths 610, 620. In one exemplary implementation of the mixer-filter 600, R₁ may be 8 kΩ, R₂ may be 25 kΩ, and C may be 5 pF. More generally, R₁ may be in the range 10Ω to 500 kΩ, R₂ may be in the range 10Ω to 500 kΩ, and C may be in the range 1 pF to 1 nF.

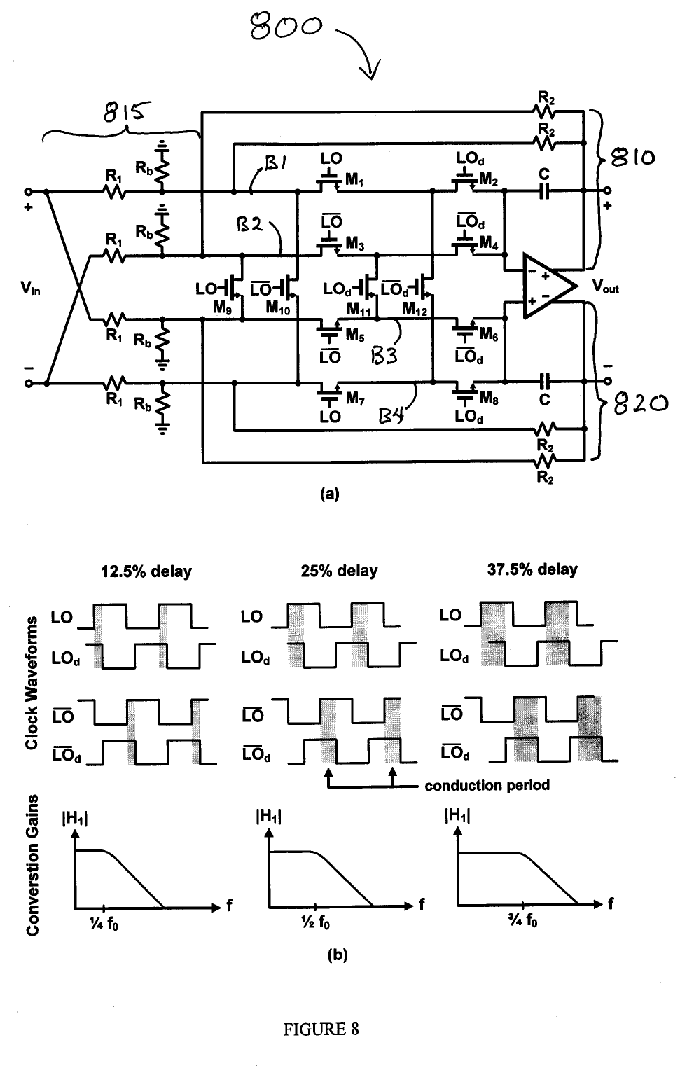

In still another exemplary configuration, a filter-mixer 800 similar to the filter-mixer 500 of FIG. 5 is provided in accordance with the present invention, FIG. 8a. One principal difference is the addition of differential shorting switches M9, M10, M11, M12 which cooperate to discharge the parasitic capacitance at the node between the pass transistors and to keep current loading through the branch resistance constant over both clock phases. Another is the addition of bias resistors R_{b} to bias the internal nodes toward ground for low voltage operation.

More specifically like the filter-mixer 500 of FIG. 5, the filter-mixer 800 includes an input Vᵢₙ, an output Vₒᵤₜ, a differential opamp 830 disposed there-between, and first and second feedback loops 810, 820 disposed between a respective output of the opamp 830 and a corresponding opamp input of the opposite polarity to that of the respective output, FIG. 8a. Similarly, the first feedback loop 810 includes a first and second branch B1, B2, and the second feedback loop 820 includes a first and second branch B3, B4. The feedback loop switches M1-M8 correspond to switches 501-508, respectively. As before the series connected NMOS switches M1-M8 perform the mixing and filter bandwidth tuning. The resistors R₂, R₁, and capacitor C occupy the same relative locations in the filter-mixer 800 as the filter-mixer 500.

In addition, between each input resistor R₁ and the feedback loops 810, 820 a bias resistor R_{b} is connected to ground. The resistors R_{b} sink common-mode current such that internal nodes can be biased at a low voltage while the input and output common-modes are biased near mid-rail. A first shorting switch M9 is disposed between branches B2, B3 on the input side of switches M3, M4; a second shorting switch M10 is disposed between branches B1, B4 on the input side of switches M1, M7; a third shorting switch M11 is disposed between branches B2, B3 on the output side of switches M3, M5; and, a fourth shorting switch M12 is disposed between branches B1, B4 on the output side of switches M1, M7. Switches M9 and M10 keep the current summing node at a low differential impedance while the series switches M1-M8 are off. Switches M11 and M12 discharge the parasitic capacitance at the node between the series switches M1-M8. In one exemplary implementation of the mixer-filter 800, R₁ may be 8 kΩ, R₂ may be 25 kΩ, R_{b} may be 12 kΩ, and C may be 5 pF. More generally, R₁ may be in the range 10Ω to 500 kΩ, R₂ may be in the range 10Ω to 500 kΩ, and C may be in the range 1 pF to 1 nF.

In this mixer-filter topology, the LO waveform performs two functions: The first function is down conversion by commutating the input signal current. The second function, is the control of the mixer-filter bandwidth through tuning of the effective LO duty-cycle. This method of bandwidth tuning is highly linear and can be used at low supply voltages.

The top part of FIG. 8b shows the clock waveforms used in the mixer-filter 800 (and optionally mixer-filter 500). All clocks have a 50% duty-cycle and are derived from the same LO. LO_{d} is a delayed version of L̅O̅ and L̅O̅_{d} is a delayed version of LO. Current flows from the input branches 815 and feedback resistor branches 810, 820 to the integrating capacitors C when paried series switches (e.g., M1-M2, M3-M4, M5-M6, M7-M8) are on. This conduction period is shown in grey in the clock waveforms, FIG. 8b. Input branch currents, through resistors R₁, are commutated while feedback branch currents, through resistors R₂, are not. Depending on the amount by which LO_{d} and L̅O̅_{d} are delayed, the conduction period length can be changed. By controlling the conduction period, the average current for a given branch input voltage can be changed. This is equivalent to changing the low frequency branch resistance. The bottom part of FIG. 8b illustrates the mixer-filter 1^{st} harmonic conversion gains for different clock delays. These conversion gains have a first order response with a corner frequency dependent on clock delay. Because changing the clock delay changes the low frequency branch resistance, an equivalent change in mixer-filter corner frequency is observed. f₀ is the cutoff frequency when the clock delay is 50%, or equivalently when conduction occurs over the entire clock period. Note that conduction occurs twice per clock period, once for the non-inverted clock and once for the inverted clock. Ignoring switch resistance, the cutoff frequency is

$${f}_{bw} = 2 \cdot d \cdot {f}_{0} = \frac{d}{π \cdot {R}_{2} C} , 0 < d \leq 0.5 \qquad ( 2 )$$

where d is the clock delay as a fraction of the clock period.

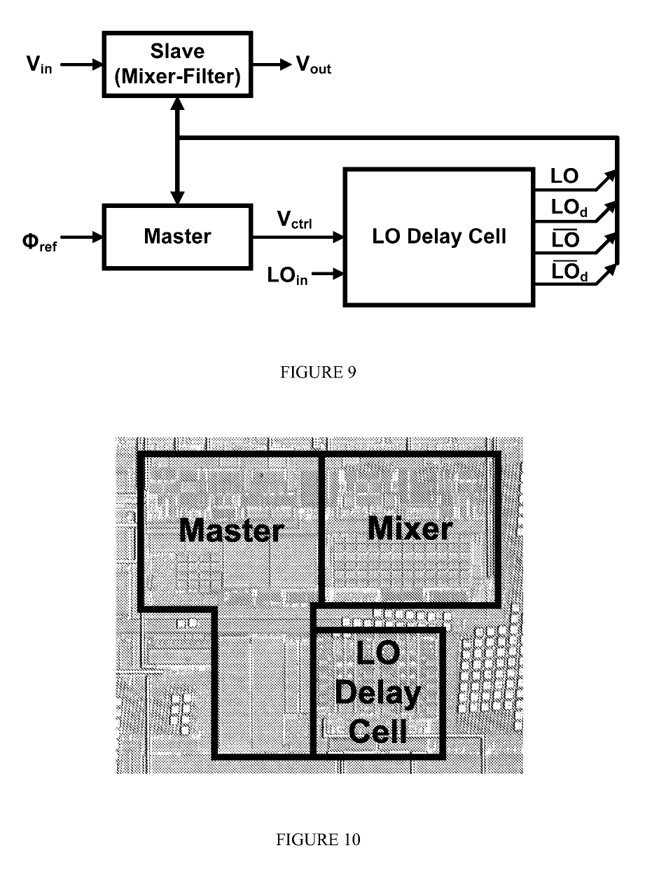

The mixer-filter bandwidth can be tuned very precisely by using the master-slave tuning scheme shown in FIG. 9. The slave is the mixer-filter 800. (Such a master-slave arrangement may be used with any of the afore-mentioned exemplary configurations.) The master contains switching branches and capacitors similar to those used in the mixer-filter 800. The time-constant created by these elements is compared to an ideal time reference Φ_{ref} and the error is output as a voltage V_{ctrl}. This error is fed back through the LO delay cell, which creates variable delay clocks, tuning the mixer-filter 800 and master to drive the time-constant error to zero. The LO delay cell consists of inverter based voltage-controlled delay lines. To change the clock delay, V_{ctrl} adjusts the output time-constant of each inverter output through MOSFET resistors.

### Experimental Results

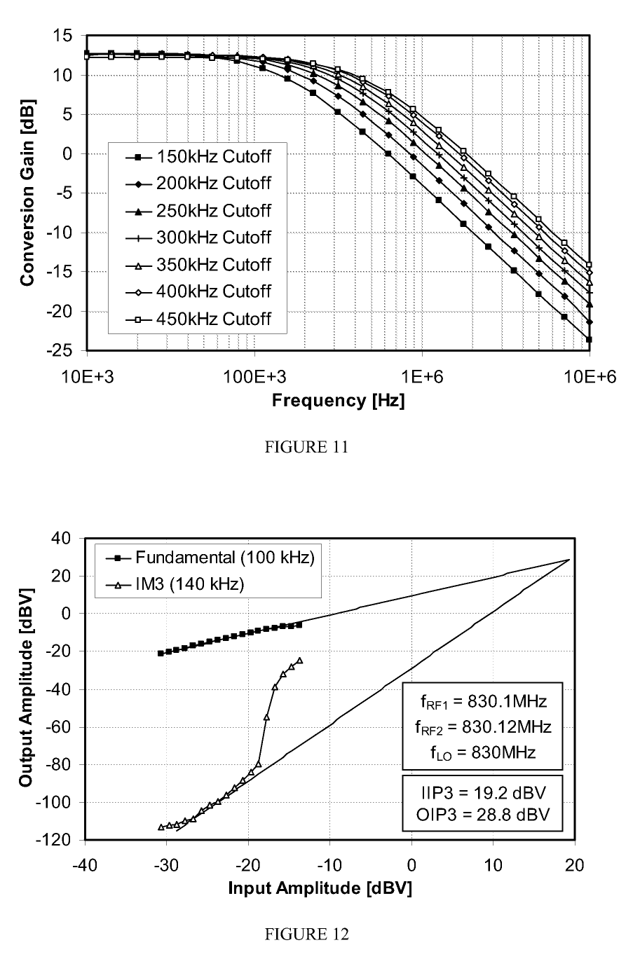

A prototype IC was fabricated in a 0.18 μm CMOS process. The die micrograph is shown in FIG. 10. R₁ is 8 kΩ, R₂ is 25 kΩ, R_{b} is 12 kΩ, and C is 5 pF. The active die area is 0.12 mm². The measured mixer-filter conversion gains over a tuning range of ±50% are shown in FIG. 11. The mixer-filter can tune from 150 kHz to 450 kHz with a nominal cutoff frequency of 300 kHz. The conversion gains vary by only 0.6 dB at DC over the ±50% tuning range. FIG. 12 shows the measured IIP3. The mixer converts and filters an 830 MHz RF input to a nominal 300 kHz bandwidth at DC. The mixer-filter achieves 19.2 dBV IIP3 while operating at 1V. The sharp rise in the 3^{rd} order intermodulation component for inputs greater than −18 dBV is caused by clamping at the opamp output. The performance of the test chip is summarized in Table I.

TABLE I

| | |
|---|---|
| Supply Voltage | 1 V |
| In band IIP3/OIP3 | 19.2 dBV/28.8 dBV |
| Out of Band IIP3/OIP3 | 11.6 dBV/21.2 dBV |
| 1 dB Compression Point (input/output) | −15.3 dBV/−6.7 dBV |
| Output SNR | 62 dB |
| (1 kHz-300 kHz, 1 Vpp diff. output) | |
| Input Frequency Band Center | 830 MHz |
| Nominal Cutoff Frequency | 300 kHz |
| Nominal Conversion Gain | 9.6 dB |
| Power Consumption | 3 mW |
| Active Area | 0.12 mm² |
| Technology | 0.18 μm CMOS |

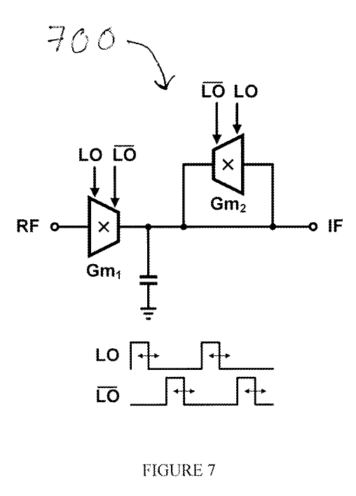

In still yet another exemplary configuration of the present invention, bandwidth control using PWM of a mixer LO may also be effected using other mixer structures such as active Gilbert style mixers as shown in FIG. 7. A first Gilbert-type mixer Gm₁ provides a mixing function, and a second Gilbert-type mixer Gm₂ provides bandwidth control using the duty-cycle of the LO. The second Gilbert-type mixer Gm₂ has an input and an output connected to the output of the first Gilbert-type mixer Gm₁. A capacitor may be disposed between ground and the output of the first Gilbert-type mixer Gm₁. The first and second Gilbert-type mixers may each be driven by the oscillator waveform and the complement of the oscillator waveform. The conversion gain of the mixer-filter 700 can be adjusted by varying the relative duty-cycles of the switches in the input branches of versus the switches in the feedback path. In one exemplary implementation of the mixer-filter 700, Gm₁ may be 125 μS, Gm₂ may be 40 μS. More generally, Gm₁ may be in the range 100 mS to 2 μS, Gm₂ may be in the range 100 mS to 2 μS.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A passive current mixer having a bandwidth that is tunable in response to a variation in the duty-cycle of a local oscillator, comprising:
a local oscillator for producing an oscillator waveform having a duty-cycle; and
an opamp having first and second feedback loops, each feedback loop including a first switch disposed therein driven by the oscillator waveform and a second switch disposed therein driven by the complement of the oscillator waveform,
wherein the bandwidth of the mixer is tunable by varying the duty-cycle of the oscillator waveform.

2. The passive current mixer according to claim 1, wherein the opamp comprises differential outputs, and wherein the first feedback loop is disposed between the positive opamp output and the negative opamp input.

3. The passive current mixer according to claim 2, wherein the second feedback loop is disposed between the negative opamp output and the positive opamp input.

4. The passive current mixer according to claim 1, comprising an input switch driven by the oscillator waveform disposed between the first feedback loop and the input to the current mixer.

5. The passive current mixer according to claim 4, comprising an additional input switch driven by the complement of the oscillator waveform disposed between the first feedback loop and the input to the current mixer.

6. A passive current mixer having a bandwidth that is tunable in response to a variation in the phase delay of a local oscillator, comprising:
a local oscillator for producing an oscillator waveform having a duty-cycle; and
an opamp having two feedback loops, each feedback loop including a first and second switch connected in series disposed therein, the first switch driven by the oscillator waveform and the second switch driven by a phase delayed version of the oscillator waveform,
wherein the bandwidth of the mixer is tunable by varying the phase delay of the oscillator waveform.

7. The passive current mixer according to claim 6, wherein each feedback loop comprises a third and fourth switch connected in series disposed therein, the third switch driven by the complement of the oscillator waveform and the fourth switch driven by a phase delayed version of the complement of the oscillator waveform.

8. The passive current mixer according to claim 7, comprising a switch driven by the phase delayed version of the oscillator waveform disposed between the respective nodes between the respective third and fourth switches of the feedback loops to discharge the parasitic capacitance.

9. The passive current mixer according to claim 7, comprising a switch driven by the oscillator waveform disposed between the respective third switches of the feedback loops to keep a current summing node of the mixer at a low differential impedance.

10. The passive current mixer according to claim 6, comprising a switch driven by the phase delayed version of the complement of the oscillator waveform disposed between the respective nodes between the respective first and second switches of the feedback loops to discharge the parasitic capacitance.

11. The passive current mixer according to claim 6, comprising a switch driven by the complement of the oscillator waveform disposed between the respective first switches of the feedback loops to keep a current summing node of the mixer at a low differential impedance.

12. The passive current mixer according to claim 6, wherein local oscillator comprises a 50% duty cycle.

13. An active mixer having a bandwidth that is tunable in response to a variation in the duty-cycle of a local oscillator, comprising:
a local oscillator for producing an oscillator waveform having a duty-cycle;
a first Gilbert-type mixer having an input and an output;
a second Gilbert-type mixer having an input connected to the output of the first Gilbert-type mixer, the second Gilbert-type mixer having an output connected to the output of the first Gilbert-type mixer and connected to the input of the second Gilbert-type mixer, the first and second Gilbert-type mixers each driven by the oscillator waveform and the complement of the oscillator waveform; and
a capacitor disposed between ground and the output of the first Gilbert-type mixer,
wherein the bandwidth of the active mixer is tunable by varying the duty-cycle of the oscillator waveform.

14. A method for tuning the bandwidth of an active mixer, comprising:
providing a local oscillator for producing an oscillator waveform having a duty-cycle;
providing a first Gilbert-type mixer having an input and an output;
providing a second Gilbert-type mixer having an input connected to the output of the first Gilbert-type mixer, the second Gilbert-type mixer having an output connected to the output of the first Gilbert-type mixer and connected to the input of the second Gilbert-type mixer, the first and second Gilbert-type mixers each driven by the oscillator waveform and the complement of the oscillator waveform;
providing a capacitor disposed between ground and the output of the first Gilbert-type mixer; and
varying the duty-cycle of the oscillator waveform to tune the mixer.

15. A method for tuning the bandwidth of a passive current mixer, comprising:
providing a local oscillator for producing an oscillator waveform having a duty-cycle;
providing an opamp having first and second feedback loops, each feedback loop including a first switch disposed therein driven by the oscillator waveform and a second switch disposed therein driven by the complement of the oscillator waveform; and
varying at least one of the duty-cycle and the phase delay of the oscillator waveform to tune the mixer.

16. The method according to claim 15, wherein the opamp comprises differential outputs, and wherein the first feedback loop is disposed between the positive opamp output and the negative opamp input.

17. The method according to claim 15, comprising providing an input switch driven by the oscillator waveform between the first feedback loop and the input to the current mixer.

18. The method according to claim 17, comprising providing an additional input switch driven by the complement of the oscillator waveform between the first feedback loop and the input to the current mixer.

19. The method according to claim 15, comprising providing a third switch driven by a phase delayed version of the oscillator waveform in each of the two feedback loops.

20. The method according to claim 19, comprising providing a fourth switch driven by a phase delayed version of the complement of the oscillator waveform in each of the two feedback loops.
